(19) United States
(12) Patent Application Publication
(10) Pub. No.: US 2011/0032099 A1
(43) Pub. Date: Feb. 10, 2011

(54) Method for Recognizing Theft of a PV Module and a Failure of a Bypass Diode of a PV Module, Corresponding PV Sub-Generator Junction Box, PV Inverter, and Corresponding PV System

(75) Inventor: Bodo Giesler, Munchen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, München (DE)

(21) Appl. No.: 12/867,175

(22) PCT Filed: Feb. 11, 2009
(86) PCT No.: PCT/EP2009/051559

§ 371 Date: Oct. 13, 2010

(30) Foreign Application Priority Data
Feb. 11, 2008 (DE) 10 2008 008 504.9

(51) Int. Cl. G08B 13/14

(52) U.S. Cl. 340/568.1

(57) ABSTRACT

A method for recognizing the theft of at least one photovoltaic module of a PV system. The PV system comprises at least one string of serially connected PV modules for supplying a field voltage, where the at least one string is connected in parallel and the PV modules each have a plurality of serially connected PV cells. In addition, bypass diodes connected in an anti-parallel manner are provided for protecting the PV cells. During a non-charging operation, i.e., the evening and at night, a test voltage that is negative relative to the field voltage is connected to the at least one PV string to adjust a test current through the bypass diodes. A theft message is automatically output when at least one of the test current and the test voltage significantly change.

### CROSS-REFERENCE TO RELATED APPLICATIONS

This is a U.S. national stage of International Application No. PCT/EP2009/051559, filed on 11 Feb. 2009. Priority is claimed on German Application No. 10 2008 008 504.9, filed on 11 Feb. 2008. The entire content of both applications are incorporated herein by reference.

### BACKGROUND OF THE INVENTION

1. Field of the Invention

The invention relates to a method for recognizing a theft of at least one photovoltaic (PV) module of a PV system which has at least one string, connected in parallel, of serially connected PV modules for supplying a field voltage. Here, the PV modules have a plurality of serially connected PV cells.

The invention furthermore relates to a method for recognizing a failure of at least one bypass diode of a PV module in a PV system which has at least one string, connected in parallel, of serially connected PV modules for supplying a field voltage, whereby the PV modules each have a plurality of serially connected PV cells and a plurality of bypass diodes connected thereto in an anti-parallel manner and serially, for protecting the PV cells.

The invention furthermore relates to a PV sub-generator junction box for a PV system, which has a plurality of electrical terminals for connection of a respective PV string line of a plurality of serially connected PV modules to a respective one of a plurality of serially connected PV cells, a sub-generator terminal for connecting a PV sub-generator line of a remotely located central PV inverter, and an electronic control unit.

The invention moreover relates to a PV inverter for a PV system having at least one sub-generator terminal for connection of a respective PV sub-generator line of a plurality of PV sub-generator junction boxes and/or for connection of a respective PV main direct current line of a PV generator junction box connected in between. The PV inverter has a power connector for connection to a power supply network and a central control unit for controlling the PV inverter.

Finally, the invention relates to a PV system having at least one conventional PV inverter or having one such central PV inverter having a plurality of such PV sub-generator junction boxes.

2. Description of the Related Art

In general, known photovoltaic (PV) systems or solar fields have a central PV inverter and a plurality of serially connected PV modules. Typically, approx. 10 to 20 PV modules are connected in series to form a string to achieve an expedient field voltage of approx. 1000 V for the PV inverter. The PV inverter then converts the DC input voltage into a single-phase, preferably into a three-phase line voltage for feeding into a power supply network.

In order to minimize line losses, the PV inverter is typically arranged in the center of the PV system. The PV modules are preferably arranged in a star shape around the PV inverter. A plurality of PV inverters may also be present. With regard to PV systems having a maximum feed-in power in excess of 100 kW, in particular in excess of 1 MW, a plurality of PV sub-generator junction boxes is present, each of which on the one hand is connected by a PV sub-generator line to the central PV inverter and which, on the other hand, is connected to a plurality of PV modules connected serially to form a string. A few strings of PV modules, such as eight, are typically connected to such a PV sub-generator junction box.

A PV sub-generator junction box has a plurality of electrical terminals for connecting the many PV string lines. The ends of the respective PV string lines can be applied and secured to these terminals. Furthermore, the PV sub-generator junction box typically has a sub-generator terminal for connecting a PV sub-generator line.

With regard to particularly large PV systems having an electrical feed-in power of several megawatts, PV generator junction boxes can in addition be connected between the many PV sub-generator junction boxes and the central PV inverter. A plurality of PV sub-generator junction boxes can radiate from such a PV generator junction box. The number of connected PV sub-generator junction boxes typically lies in a range from 16 to 20. Such types of PV systems can occupy an area of many hectares, whereby several hundred to several thousand PV modules can be arranged in a distributed manner.

Because of the high unit cost of a PV module of several hundred euros, the risk of theft of such extensive PV systems is especially high. For some time, as the demand for PV modules has risen, so too has the number of thefts increased sharply. The consequence is that following a theft of PV modules a number of insurance companies have for their part canceled the policy or have increased the premiums to such an extent that an insurance policy is economically feasible only to a limited extent.

A known method for rendering theft more difficult is to fence in the entire area of a PV system. Acoustic, optical and mechanical monitoring systems, such as motion sensors or cameras, then raise an alarm when activities have been detected in the area of the fence. Such systems are, however, on the one hand, very expensive and, on the other hand, error-prone, particularly if wildlife comes into the vicinity of the fence.

Furthermore, monitoring systems are also known which are based on an indicator wire that is routed through frame profiles of a framed PV module. Such monitoring systems are, however, easily recognizable and can be easily tampered with, by being bypassed, for example, by “skilled” thieves.

A further known possibility is to monitor the symmetry of the string currents of a plurality of serially connected PV modules. To this end, current measuring units for acquiring the string currents are present in known PV sub-generator junction boxes. A monitoring unit triggers an alarm when one of the measured string currents deviates appreciably from the other measured string currents. An example of such a monitoring unit is the “Sunny String Monitor” from the company SMA. Such systems function reliably in the daytime.

It is disadvantageous that a monitoring of symmetry, however, is no longer possible in the evening or at night due to the lack of presence of a significant string current. Typically, the central PV inverter is also switched off when a feed-in power of approx. 10 W/m² is not reached because the electrical power loss of the PV inverter is then for the most part, greater than the feed-in power that still remains available. However, by far the most thefts occur directly under the cover of darkness.

In addition, for the operation of a PV system, a recurrent expensive measuring system is required to continuously check the quality of the PV modules. This measurement normally occurs within the scope of a field measurement. One aspect of the measurement is also the measurement of bypass diodes which are normally present in all PV modules for protecting the plurality of PV cells. The bypass diodes are connected in an anti-parallel manner to a series of PV cells to prevent faulty PV cells from burning out, in the event of a defect or when placed in partial shade. In these cases, the entire string current then no longer flows through these PV cells but through the parallel bypass diode. However, these bypass diodes can become high-impedance or also low-impedance as a result of ageing or lightning damage and thus fail. As a result, protection of the PV modules is no longer guaranteed, with the result that an entire string of PV modules needs to be switched off in the event of a fault. On the other hand, the bypass diodes, may short and fail, such as when a thermal overload occurs. In this case, the efficiency, i.e., the partial field voltage, of such a PV module decreases.

### SUMMARY OF THE INVENTION

It is therefore an object of the invention to provide a simpler and at the same time more reliable method for recognizing the theft of a PV module.

A further object of the invention is to provide a simpler and at the same time more reliable method for recognizing a failure of a bypass diode in a PV module.

Furthermore, an object of the invention is to provide a PV sub-generator junction box corresponding to the methods.

Finally, an object of the invention is to provide a suitable PV inverter and a PV system having a plurality of such PV sub-generator junction boxes.

These and other objects and advantages are achieved in accordance with the invention by providing a method for recognizing the theft of at least one PV module, by providing a method for recognizing a failure of at least one bypass diode, by a PV sub-generator junction box corresponding to the method, by a suitable PV inverter; by a PV system having a PV inverter and having a plurality of such PV sub-generator junction boxes, and by providing a PV system having an inventive PV inverter and having a plurality of inventive PV sub-generator junction boxes.

In accordance with the invention, bypass diodes connected in an anti-parallel manner are provided for protecting the PV cells. During non-feeding operation, i.e., in the evening and at night, a test voltage that is negative relative to the field voltage is connected to the at least one PV string line to set a test current through the bypass diodes. A theft message is automatically output when the test current changes significantly at a given test voltage or when the test voltage changes significantly at a given test current.

The major advantage is that any significant change in the test current or the test voltage is a sure indication that tampering is occurring in a respective PV string.

“Significant” particularly means a rapid drop in the test voltage at a given constant test current in a period of less than one second. A significant change exists, for example, in the situation when the test voltage changes by at least a few volts. By preference, the impressed test current has an amperage in the range 10 mA to 100 mA. In other words, the impressed current has an amperage at which a forward voltage dropping across the respective bypass diodes is essentially constant. The forward voltage lies, for example, in the case of silicon diodes, depending on type, in the range of between 0.7 V to 1 V. An increase in the test voltage to a maximum measurement voltage value or open circuit voltage is then in particular an indication of the fact that a PV string line has been interrupted, such as for example in the event of the theft of a PV module. Here, the theft message can contain the advice that a PV string line has been opened. If, however, the test voltage decreases by a few volts, then the theft message can contain the advice that at least one PV module has been jumpered. Here, the forward voltages dropping across the bypass diodes of the stolen PV module are missing.

In a corresponding manner, a constantly supplied test voltage can be used instead of a constantly supplied test current. Here, an interruption of the associated test current indicates an opening of the PV string line. An increase in the test current, on the other hand, indicates a jumpering of one or more PV modules because in this case the overall resistance of the PV string line is reduced.

In accordance with an embodiment of the method of the invention, the theft message is output when, at a given test current, a presently acquired test voltage drops by approximately the sum of the forward voltage values of all the bypass diodes of a PV module or an integral multiple thereof. Here, a precise number of the PV modules which it is suspected have been jumpered can advantageously be output as part of the error message.

With reference to the first method for recognizing a failure of at least one bypass diode, according to the invention, during non-feeding operation, i.e., in the evening and at night, a test voltage that is negative relative to the field voltage is connected to a PV string line of the serially connected PV modules to set a test current through the bypass diodes. A failure message is automatically output when a presently acquired test voltage drops in comparison with an already previously measured comparison voltage by approximately an integral multiple of the forward voltage of a bypass diode.

It is thereby possible to perform checking of all bypass diodes in a respective PV string line, i.e., in the evening and at night. For comparison purposes, a comparison voltage measured the previous day is preferably used. Given an identical test current, when a presently acquired test voltage is, for example, approx. 0.7 V less compared with the previous day, then this is a sure indication that precisely one bypass diode is short-circuited, i.e., has failed.

With reference to the second method for recognizing a failure of at least one bypass diode, according to the invention the failure message is output in the situation when on account of an open-circuit state of at least one of the bypass diodes instead of the test current to be set only a residual current smaller in comparison therewith can be set. This is the case, for example, in situations when only a fraction, such as 30%, of the usual regulated test current can be impressed in the respective PV string line when a maximum test voltage is applied.

In accordance with an embodiment, a plurality of strings is connected in parallel. A respective string test current is set in the respective string to recognize a string-related theft or a bypass diode failure. Thus, it is possible to monitor each PV string line for a failure of bypass diodes.

As a consequence of a special embodiment, the respective string test current is set cyclically in one of the respective strings. As a result, the circuit structure is considerably simplified.

The object of the invention is furthermore achieved by a PV sub-generator junction box which, in accordance with the invention, is configured to switch a test voltage that is negative relative to the field voltage to the PV sub-generator line during non-feeding operation, i.e., in the evening and at night, such that a test current through one or more bypass diodes of the PV modules can be set.

The PV sub-generator junction box has a voltage measuring unit for acquiring the test voltage and/or at least one current measuring unit for acquiring the test current. A theft message can be output by the control unit when the test current and/or the test voltage changes significantly. A failure message for at least one bypass diode can be output by the control unit when a presently acquired test voltage drops in comparison with a previously measured comparison voltage by approximately an integral multiple of the forward voltage of a bypass diode, or when on account of an open-circuit state of at least one of the bypass diodes instead of the test current to be set only a residual current smaller in comparison therewith can be set. In particular, the theft message can be output when, at the set test current value, an associated test voltage value drops by a voltage value which corresponds essentially to the sum of the forward voltage values of all the bypass diodes of a PV module or an integer multiple thereof.

In an advantageous embodiment, each respective PV sub-generator junction box has a switching device which can be controlled by the control unit for switching on a PV string line of a respective string. In each case, only one switching device for setting a respective string test current in the respective string can be cyclically controlled for the possible output of a string-related theft message or failure message.

In a further embodiment, the PV string lines are connected to a bus bar of the PV sub-generator junction box. The PV sub-generator junction box has a disconnection device which can be controlled by the control unit for disconnecting the PV sub-generator line from the bus bar. Furthermore, the PV sub-generator junction box has a test voltage supply for providing the test voltage and also a switch which can be controlled by the control unit for switching the test voltage to the bus bar.

In particular, the test voltage supply for the electrical supply is connected on the input side to the sub-generator terminal of the PV sub-generator junction box. As a result, it is possible to provide an electrical supply to the inventive PV sub-generator junction box through the central PV inverter.

In accordance with a particular embodiment, the test voltage supply has an energy store, i.e., an accumulator, which can be charged through the sub-generator terminal. The particular advantage of this embodiment is that interruption-free monitoring of the PV modules and also interruption-free checking of the bypass diodes are possible in the evening and at night, even when the power module of the central PV inverter is switched off. At the commencement of a feeding operation, i.e., typically the following morning, the energy store can be recharged through the sub-generator terminal.

The object of the invention is furthermore achieved by a PV inverter which has an auxiliary voltage supply for providing an auxiliary voltage and also a coupling switch for feeding the auxiliary voltage into the PV sub-generator lines and/or PV main direct current lines. As a result, an auxiliary voltage can advantageously be fed in by the PV sub-generator lines to the respective inventive PV sub-generator junction boxes when the power module is shut down in the event of a lack of solar feed-in.

In accordance with an embodiment, the auxiliary voltage supply provides an auxiliary voltage (i.e., negative relative to the fed-in field voltage), a positive auxiliary voltage or an auxiliary alternating voltage. The auxiliary voltage supply is preferably a power supply unit which is connected on the input side to the power supply system, into which the PV inverter feeds during feeding operation.

In the case of a fed-in negative auxiliary voltage, this can be used directly by the respective PV sub-generator junction boxes as a test voltage for setting a test current through the bypass diodes for recognizing a theft and/or for checking the bypass diodes.

Alternatively, the auxiliary voltage can have the same polarity with respect to the field voltage. In this case, the auxiliary voltage is used for the electrical supply to the test voltage supplies in the respective PV sub-generator junction boxes.

Furthermore, the auxiliary voltage can be an alternating voltage. In this case, the auxiliary voltage supply is preferably a transformer which is connected on the input side to the power supply network.

The aforementioned auxiliary voltages have values of less than 100 V, typically less than 40 V.

In accordance with the invention, the object of the invention is achieved by a PV system having at least one central PV inverter and having a plurality of such PV sub-generator junction boxes.

Alternatively, the PV system has a central PV inverter for supplying electricity to the PV sub-generator junction boxes when the power module is shut down, i.e., in the evening and at night.

Finally, in accordance with an advantageous embodiment, the PV system has at least one PV generator junction box connected between the at least one central PV inverter and the plurality of PV sub-generator junction boxes.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and advantageous embodiments of the invention will be described in detail in the following with reference to the following drawings, in which:

FIG. 1 is an illustration of a flowchart of a method for recognizing a theft in accordance with an embodiment of the invention;

FIG. 2 is an illustration of a flowchart of a method for recognizing a failure of at least one bypass diode in accordance with an embodiment of the invention;

FIG. 3 is an illustration of a schematic block diagram of a PV system in accordance with the prior art;

FIG. 4 is an illustration of an exemplary schematic block diagram of a series connection comprising a plurality of PV modules each having a plurality of PV cells and each having a plurality of bypass diodes connected in an anti-parallel manner in accordance with the prior art;

FIG. 5 is an illustration of a schematic block diagram of a PV sub-generator junction box in accordance with the prior art;

FIG. 6 is an illustration of an exemplary schematic block diagram of a PV sub-generator junction box in accordance with the invention;

FIG. 7 is an illustration of an exemplary schematic block diagram of a PV inverter in accordance with the invention; and

FIG. 8 is an illustration of an exemplary schematic block diagram of a PV sub-generator junction box in accordance with an embodiment of the invention.

### DETAILED DESCRIPTION OF THE PREFERRED EMBODIMENTS

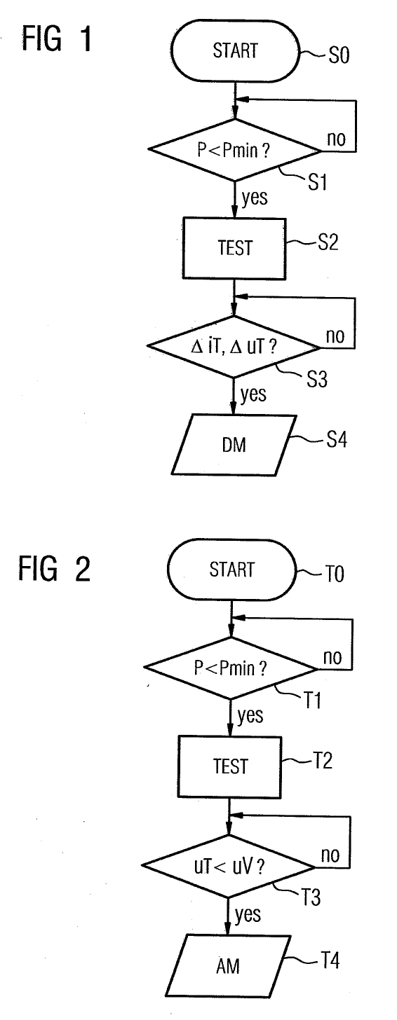

FIG. 1 is an illustration of a flowchart of a method for recognizing a theft. S0 designates a start step. A query is made in the following step S1 as to whether feeding operation is presently occurring in the PV system 100. To this end, a comparison is performed of the present electrical feed-in power P with a minimum feed-in power Pmin for which the operation of the power module of the PV inverter remains economical. If this is the case, a branch back to step S1 occurs. Otherwise, in step S2 denoted by “TEST”, i.e., during non-feeding operation i.e., in the evening and at night, a test voltage that is negative relative to the field voltage uT is connected to the at least one PV string line to set a test current iT through the bypass diodes. In the following step S3, a check is made to determine whether the test current iT changes significantly at a given test voltage uT or the test voltage uT changes significantly at a given test current iT. If no change is ascertained, a branch back to the step S3 occurs. Otherwise, a theft message DM is automatically output, i.e., when the presently acquired test voltage uT at a given test current iT drops by approximately the sum of the forward voltage values of all the bypass diodes of a PV module or an integral multiple thereof.

FIG. 2 shows a flowchart of a method for recognizing a failure of at least one bypass diode in accordance with the invention. The steps T0 to T2 correspond to the steps S0 to S2 according to the method described previously. In the following step T3, a check is to determine whether a presently acquired test voltage uT drops in comparison with an already previously measured comparison voltage uV by approximately an integral multiple of the forward voltage of a bypass diode. If no change is ascertained, a branch back to step T3 occurs. Otherwise, a failure message AM is automatically output.

Alternatively, but not represented as a flowchart, a given test current iT through the bypass diodes can be set. Here, the failure message AM can be output in the corresponding step T3 when, due to an open-circuit state of at least one of the bypass diodes instead of the test current to be set iT, only a residual current smaller in comparison therewith can be set. By preference, the test voltage uT is limited to a maximum voltage value. Should no test current iT at all then be set, or instead of the test current to be set iT only a residual current smaller in comparison therewith, then this is a sure indication of the failure of a bypass diode.

For the three previously described methods, with regard to a plurality of strings connected in parallel a respective string test current can be set in the respective string for recognizing a string-related theft or a bypass diode failure, whereby the respective string test current is then preferably set cyclically in one of the strings in each case.

The contemplated embodiments of the methods of the invention are preferably implemented as software routines on an electronic control unit of the PV sub-generator junction box 1. The control unit is preferably a microcontroller or processor.

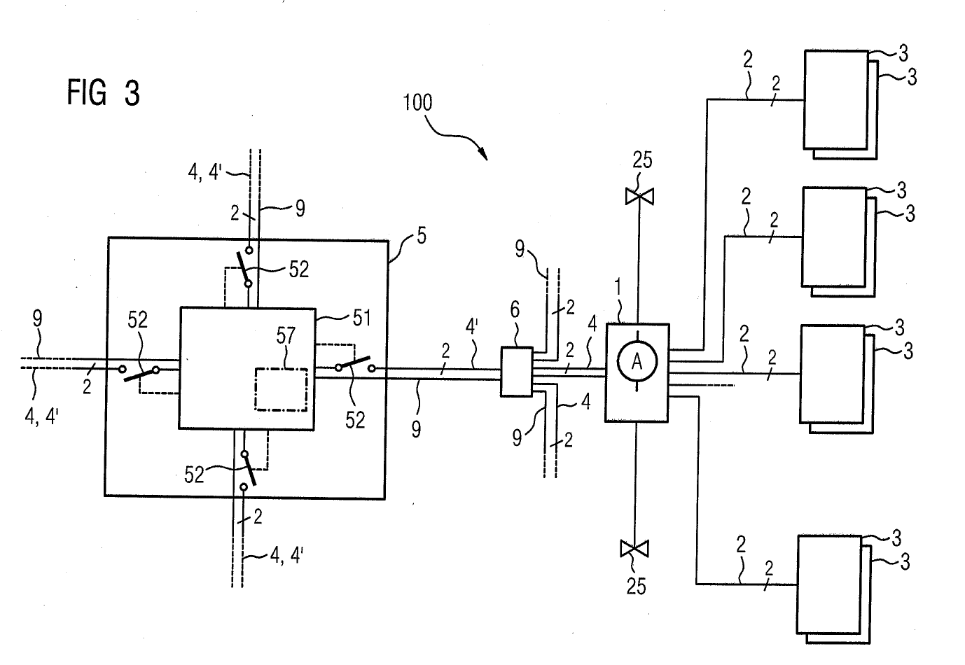

FIG. 3 shows a PV system 100 in accordance with the prior art. A PV inverter denoted by the reference character 5 is illustrated in the left-hand part of FIG. 3. By way of example, four PV sub-generator lines 4 or four PV main direct current lines 4′ radiate from the PV inverter 5 shown. The bar bearing the reference character 2 incorporated in each of the PV sub-generator lines 4 or PV main direct current lines 4′ indicates that the line in question is preferably two-core. The respective PV sub-generator lines 4 or PV main direct current lines 4′ can be disconnected from a power module 51 of the PV inverter 5 by a controllable disconnection device 52. The control is preferably effected by a central control unit 57. Illustrated in parallel with the four PV sub-generator lines 4 or PV main direct current lines 4′ is a respective communication line 9 for the bidirectional transfer of data DAT between the central PV inverter 5 and the respective PV sub-generator junction boxes 1 shown in the right-hand part of FIG. 3.

Illustrated by way of example in the center part of FIG. 3 is a PV generator junction box 6 which, with respect to the solar feed-in power, is connected on the input side to three PV sub-generator junction boxes 1 and on the output side to the central PV inverter 5. For reasons of clarity, however, only one PV sub-generator junction box 1 and only one PV generator junction box 6 are represented in the example shown in the present FIG. 3. A PV generator junction box 6 is not necessarily required for smaller PV systems 100. In this case, the respective PV sub-generator junction box 1 is connected directly to the PV inverter 5 by a PV sub-generator line 4. As FIG. 3 also shows, in the event of a PV generator junction box 6 being present, the communication lines 9 are likewise distributed further to the respective PV sub-generator junction box 1.

Reference character 25 by way of example designates a final control element which can be controlled through the PV sub-generator junction box 1 in order, for example, to track a PV module 3 according to the respective position of the sun. The symbol for an ammeter entered in the box for the PV sub-generator junction box 1 symbolizes the possible presence of current measuring units in the PV sub-generator junction box 1. The current measuring units are used for acquiring individual string currents in PV string lines 2 which lead to connected PV modules 3, and/or for acquiring an entire bus current.

Five PV modules 3 connected in series to form a string 31-3n are illustrated by way of example in the right-hand part of FIG. 3. The series connection is represented graphically by the displaced arrangement in the drawing of a second PV module 3.

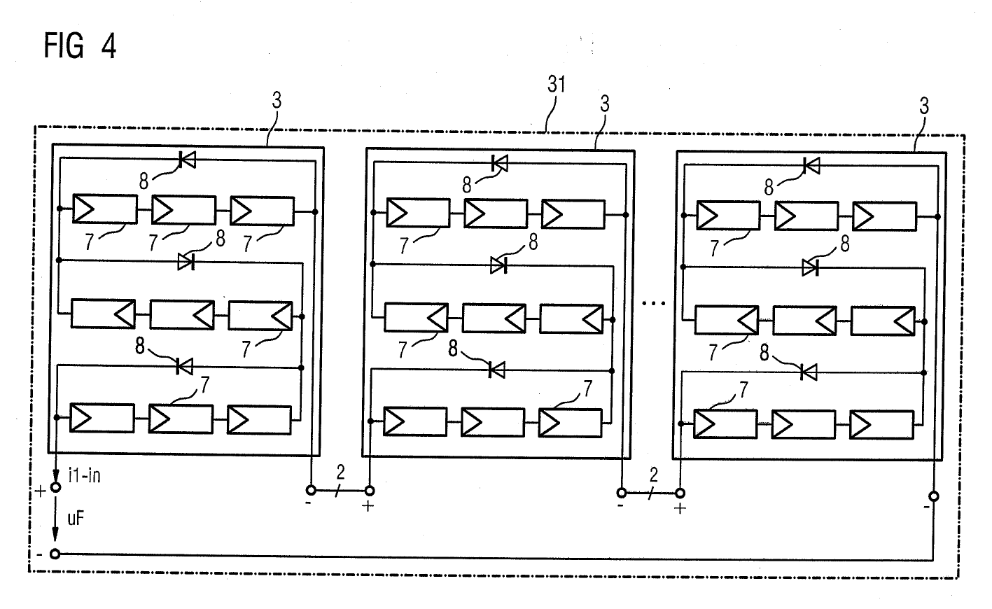

FIG. 4 shows by way of example a series connection comprising a plurality of PV modules 3 each having a plurality of PV cells 7 and each having a plurality of bypass diodes 8 connected in an anti-parallel manner in accordance with the prior art. Three PV modules 3 are connected in series in the present example. The ellipsis drawn between the center and right-hand PV modules 3 indicate that a plurality of such PV modules 3 can be connected in series, such as 18 PV modules 3. Typically, PV module types of the same, i.e., identical, construction and an equal number of serially connected PV modules 3, are used for a PV system 100, which are then connected in parallel in the respective PV sub-generator junction box 1. For decoupling purposes the respective strings 31-3n can have a decoupling diode, preferably in the respective PV sub-generator junction box 1. Furthermore, each PV module 3 has, for example, 10 to 30 bypass diodes 8 which in each case are connected in an anti-parallel manner with three PV cells 7. Illustrated in the left-hand part of FIG. 4 are terminals, bearing no further designation, at which the field voltage uF is present. i1-in designates the associated string current which, during feeding operation and given fault-free PV cells 7, flows in its entirety through the PV cells 7. Only in the event of failure of a PV cell 7 or shaded conditions does at least a large part of the string current i1-in flow through the bypass diode 8 connected in parallel. During non-feeding operation, i.e., in the evening and at night, the PV cells 7 exhibit behavior more in accordance with Ohm's law. A test voltage uT, having a negative polarity relative to the field voltage uF, then present at the respective string 31-3n causes a test current that is being set or has been set to be largely, i.e., almost in its entirety, routed through the bypass diodes 8. In this situation, the signs of the string currents i1-in and of the respective test current have the same polarity.

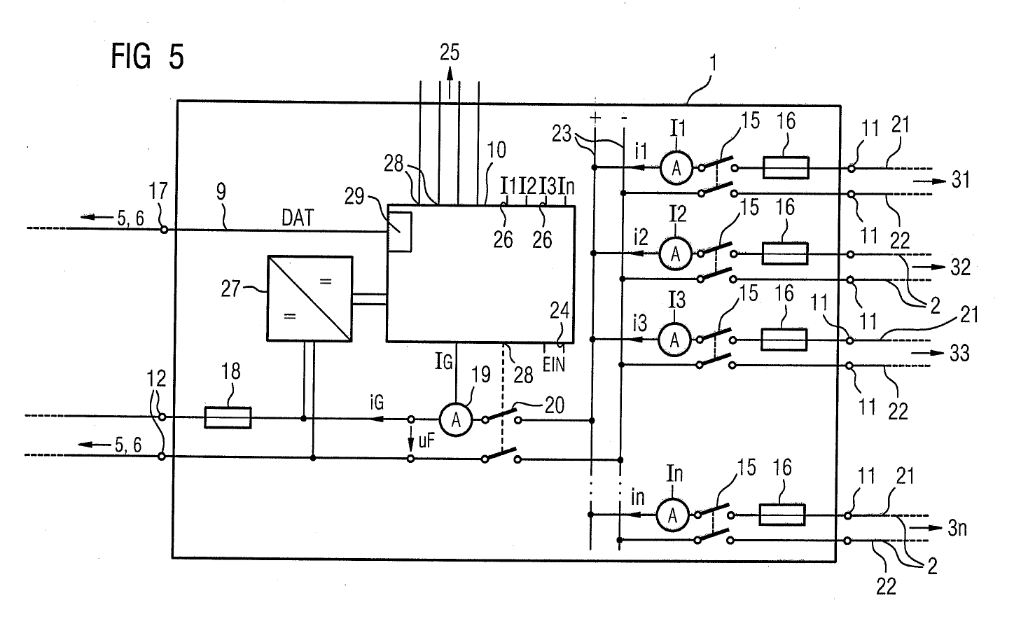

FIG. 5 shows a PV sub-generator junction box 1 in accordance with the prior art. The PV sub-generator junction box 1 shown here has, for example four electrical terminals 11 for connection of a respective PV string line 2 of one or more PV modules 3 connected in series. The reference character 21 designates a positive conductor and the reference character 22 a negative conductor of the PV string line 2. In addition, the PV sub-generator junction box 1 shown has a sub-generator terminal 12, by which the PV sub-generator junction box 1 can be connected to the central PV inverter 5 or to the PV generator junction box 6.

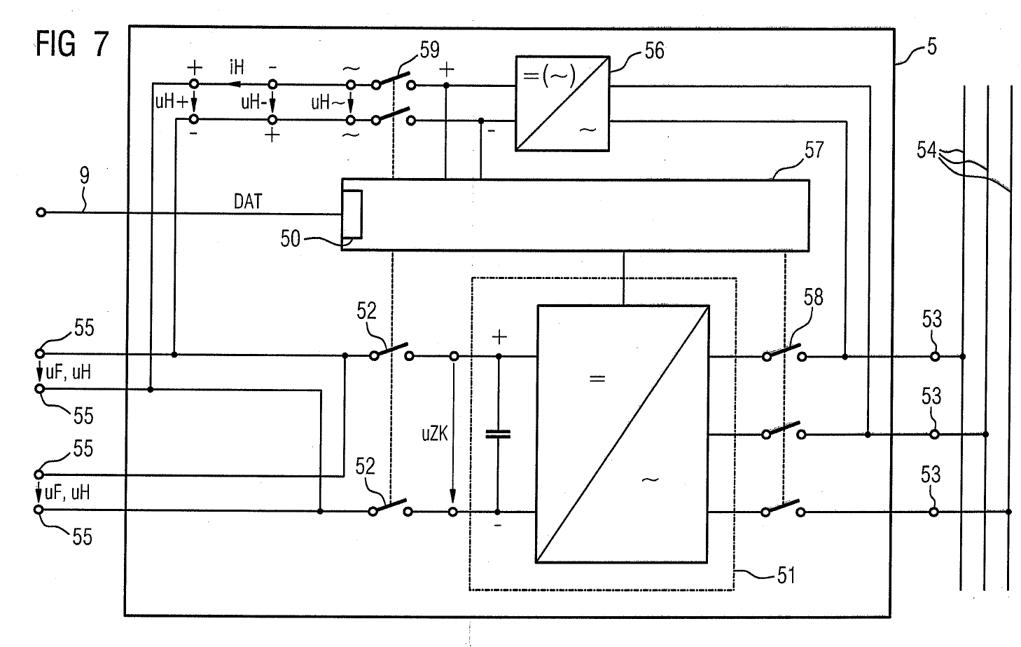

Furthermore, the PV sub-generator junction box 1 has an electronic control unit 10 which has a data link with the central control unit 57 (see FIG. 7) of the PV inverter 5 for the purpose of exchanging data DAT. The data DAT in question can be control data, diagnostic data or operational data, or also current or voltage measurement values, which are acquired on the branch side. To this end, the control unit 10 has a bus interface 29, at which the communication line 9 can be connected. The reference character 17 designates a terminal of the communication line 9. The control unit 10 itself is preferably a microcontroller or a microcomputer. The control unit 10 furthermore has electrical outputs 28, to which final control elements, such as trackers, can be connected. The control of the electrical outputs 28 is effected by a corresponding program of the electronic control unit 10. The control unit 10 furthermore has, for example four current measurement inputs 26 for acquiring corresponding string current measurement values I1-In. The latter originate from a respective current measuring unit 14 which is connected into the respective PV string line 2 for acquiring a respective string current i1-in. The reference character 24 designates electrical inputs of the control unit 10, for the acquisition as input signals EIN, for example, of acknowledgment signals from a switching device, such as a disconnection device 20, and also other states to be acquired in the PV sub-generator junction box 1. The input data DAT corresponding thereto can in turn be output over the communication line 9 to the central control unit 57 of the PV inverter 5.

Connected in series with the respective current measuring unit 14 are furthermore a disconnecting switch 15 and a cutout 16 for protecting the respective PV string line 2. With regard to the disconnecting switches 15 shown, these are normally switches which can be manually actuated. All four of the PV string lines 2 shown are connected in parallel to a common bus bar 23 which for its part is connected to the PV sub-generator line 4. In the PV sub-generator junction box 1, a cutout 18 for group protection and also a further current measuring unit 19 for acquiring a collector current iG are connected into the PV sub-generator line 4. A corresponding collector current measurement value IG can be acquired by the electronic control unit 10, further processed and where applicable forwarded over the communication line 9 to the central control unit 57 of the PV inverter 5. The disconnection device 20, which can be controlled by the control unit 10 for group disconnection of the PV sub-generator lines 2, is represented in series with the further current measuring unit 19.

A voltage supply comprising a DC/DC converter 27, which converts the high-voltage field voltage uF normally present at the PV sub-generator line 4 into a low-voltage supply for the control unit 10 of the PV sub-generator junction box 1, is furthermore connected between the control unit 10 shown and the PV sub-generator line 4.

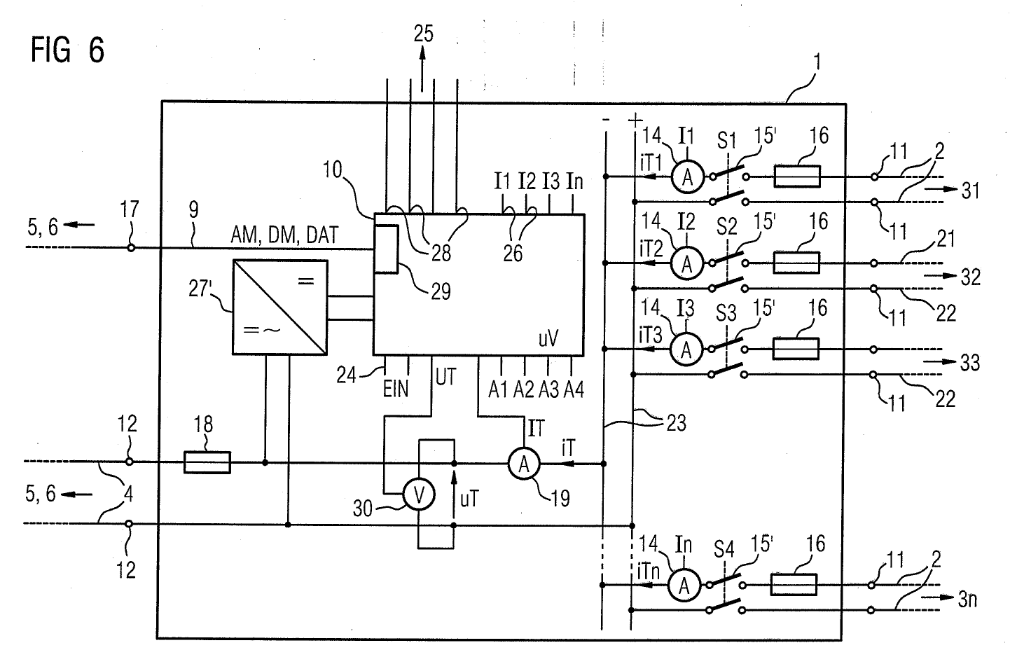

FIG. 6 is an exemplary schematic block diagram of a PV sub-generator junction box 1 in accordance with the invention. The circuit configuration shown differs from that shown in FIG. 5 in that the PV sub-generator junction box 1 shown in FIG. 6 is configured to switch a test voltage uT to the PV sub-generator line 4. In this situation, the test voltage uT has a negative polarity with respect to the field voltage uF. This can be recognized in FIG. 6 by the reversed signs “+” and “−” on the bus bar 23 as compared with FIG. 5. In the example illustrated in FIG. 6 an enhanced voltage supply 27′ is furthermore provided which is additionally capable of converting negative input DC voltages and also alternating voltages into a low voltage for supplying the control unit 10. Switching of the test voltage uT preferably occurs during non-feeding operation. To this end, the control unit 10 of the PV sub-generator junction box 1 can contain as data DAT a corresponding control command from the central PV inverter 5. Alternatively, an optical radiation sensor connected to the PV sub-generator junction box 1 can deliver a corresponding criterion. When the test voltage uT is switched on, a test current iT through one or more bypass diodes 8 of the connected PV modules 3 can be set. The test voltage uT is fed in, for example, through the electrical terminals 12. The feeding-in can occur, for example, through an external voltage source or over the PV sub-generator line 4 through the PV inverter 5.

Furthermore, the PV sub-generator junction box 1 has a voltage measuring unit 30 that is used for acquiring the test voltage uT during non-feeding operation. The voltage measuring unit 30 can advantageously additionally be used for measuring the field voltage uF present at the bus bar 23 during feeding operation. UT designates the test voltage measurement value corresponding to the acquired test voltage uT, which can be acquired and further processed by the control unit 10. A theft message DM can then be output the control unit 10 when the test voltage uT changes significantly at a given test current iT.

Alternatively or in addition, the PV sub-generator junction box 1 has a respective current measuring unit 14 for acquiring the string currents i1-in during feeding operation and also for acquiring the respective string test currents iT1-iTn during non-feeding operation. Alternatively or in addition, a further current measuring unit 19 can be present, as shown in the example depicted in FIG. 6. The current measuring unit 19 is used for acquiring the entire test current iT for the situation where all string switching devices 15′ which can be controlled by means of the control unit 10 are closed. The further current measuring unit 10 is additionally used for acquiring a collector current iG. iT designates the corresponding test current measurement value. The theft message DM can then be output by the control unit 10 when the test current iT changes at a given test voltage uT. In the present example, the theft message DM is output by the control unit 10 over the communication line 9 to the central PV inverter 5.

Alternatively or in addition, a failure message AM for at least one bypass diode 8 can be output by the control unit 10 when a presently acquired test voltage uT, such as the voltage measuring unit 30, drops in comparison with an already previously measured comparison voltage uV by approximately an integral multiple of the forward voltage of a bypass diode 8. The comparison voltage uV is, for example, stored in the control unit 10 in a non-volatile manner. The failure message AM is again output over the communication line 9.

Alternatively or in addition, the failure message AM can also be output in the situation when, instead of the test current to be set iT because of an open-circuit state of at least one of the bypass diodes 8, only a residual current smaller in comparison therewith can be set.

The test voltage uT is switched on cyclically, for example, by the string switching device 15′ which can be controlled by the control unit 10. A1-A4 designate the corresponding control signals A1-A4. As a result, a string-related theft message DM or failure message AM can be output. Typically, the PV sub-generator junction box 1 has a respective current measuring unit 14 for the continuous measurement of a respective string current i1-in. Here, it is possible to dispense with the further current measuring unit 19. Through the cyclical control of the string switching device 15′, it is then possible to ascertain a respective string test current iT1-iTn.

FIG. 7 is an exemplary schematic block diagram of a PV inverter 5 in accordance with the invention. The PV inverter 5 shown has, for example, two sub-generator terminals 55 for connection of a respective PV sub-generator line 4 of a plurality of PV sub-generator junction boxes 1 (not further shown). Alternatively or in addition, a PV main direct current line 4′ of a PV generator junction box 6 connected in between can also be present at the sub-generator terminals 55. Furthermore, the PV inverter 5 has a power connector 53 for connecting the PV inverter 5 to a power supply network (not otherwise denoted). The reference character 54 designates power supply lines. Furthermore, the PV inverter 5 has the central control unit 57 for controlling the PV inverter 5 and also for transferring data DAT to the plurality of PV sub-generator junction boxes 1 having a data link with the central control unit 57.

Furthermore, the reference character 51 designates a power module of the PV inverter 5, which converts the high-voltage field voltage uF or intermediate circuit voltage uZK present into a three-phase line voltage. Alternatively, the PV inverter 5 can also convert the field voltage uF present on the input side into a single-phase alternating voltage.

In accordance with the invention, the PV inverter 5 has an auxiliary voltage supply 56 for providing an auxiliary voltage uH and also a coupling switch 59 for feeding the auxiliary voltage uH into the PV sub-generator lines 4 and/or PV main direct current lines 4′. iH designates the associated auxiliary current. As a result, the PV sub-generator junction boxes 1 connected to the PV inverter 5 continue to be supplied with energy even when the power module 51 of the PV inverter 5 is shut down, i.e., in the evening and at night.

In the exemplary embodiment shown in FIG. 7, three possible voltage forms of the fed-in auxiliary voltage uH are entered. If the auxiliary voltage uH is a negative auxiliary voltage uH− with respect to the fed-in field voltage uF, then this auxiliary voltage uH− can be output centrally as a test voltage uT by the PV inverter 5 to the PV sub-generator junction boxes 1. The respective PV sub-generator junction boxes 1 can acquire a respective string-related string test current iT1-iTn and/or an entire test current iT with the current measuring units 14, 19. A theft message DM and/or a failure message AM can then be generated by the control unit 10. The messages DM, AM can be forwarded over the communication line 9 to the central control unit 57 of the PV inverter 5.

If the auxiliary voltage uH is a positive auxiliary voltage uH+ with respect to the fed-in field voltage uF or an auxiliary alternating voltage UH˜, then the respective PV sub-generator junction box 1 preferably has a suitable test voltage supply 40 for generating the test voltage uT from the auxiliary voltage uH. The auxiliary voltage supply 56 of the PV inverter 5 is preferably a power supply unit which is connected on the input side to the power supply system, into which the PV inverter 5 feeds during feeding operation.

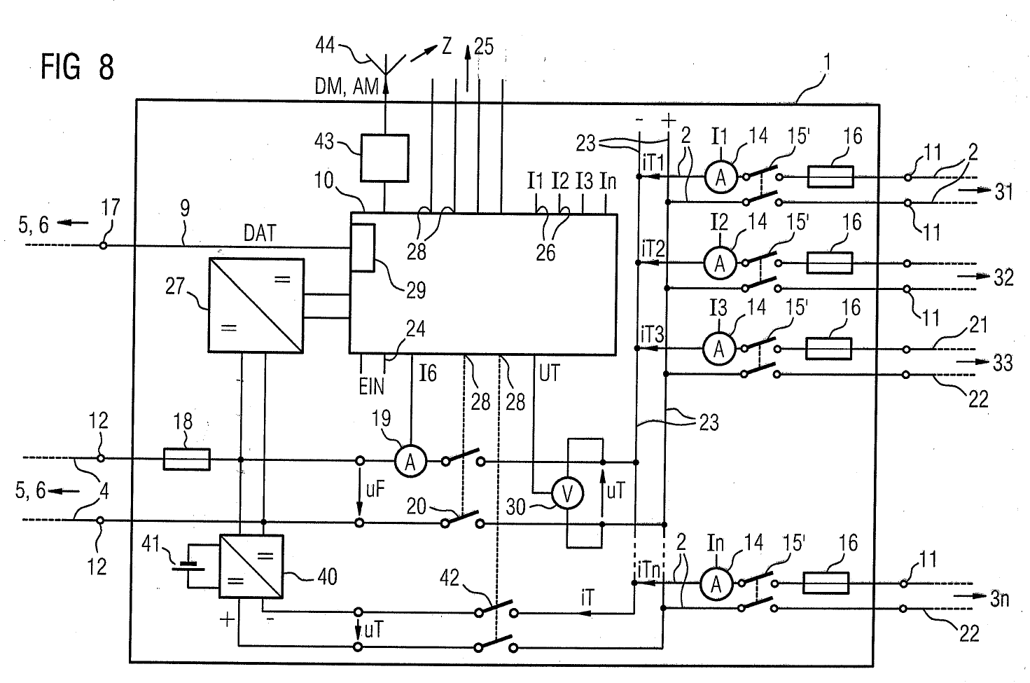

FIG. 8 is an exemplary schematic block diagram of a PV sub-generator junction box 1 in accordance with an embodiment of the invention. The circuit of FIG. 8 differs from that of FIG. 6 in that the PV sub-generator junction box 1 of FIG. 8 has a disconnection device 20 for disconnecting the PV sub-generator line 4 from the bus bar 23. The disconnection device 20 can be controlled by the control unit 10. Furthermore, the PV sub-generator junction box 1 has a test voltage supply 40 for delivering the test voltage uT and also a switch 42 which can be controlled by the control unit 10 for switching the test voltage uT to the bus bar 23. The disconnection device 20 and the switch 42 are preferably switched at the same time, i.e., the disconnection device 20 is switched off and the switch 42 switched on, or the disconnection device 20 is switched on and the switch 42 is switch off, at the same time. Furthermore, the test voltage supply 40 for the electrical supply is connected on the input side to the PV sub-generator line terminal 12 of the PV sub-generator junction box 1. By way of the PV sub-generator line terminal 12, it is possible during test operation, i.e., in the evening and at night, to supply the test voltage supply 40 with energy, such as by the auxiliary voltage uH coupled into the PV sub-generator line 4 or into the PV main direct current line 4′, by the central PV inverter 5 when the power module 51 is shut down.

Alternatively or in addition, the test voltage supply 40 has an energy store 41, i.e., an accumulator, which can be charged by the sub-generator terminal 12. As a result, an electrical feed of the test voltage uT for theft monitoring and for checking the bypass diodes 8 is also possible in the evening or at night and, in particular, if the provision to couple in an auxiliary voltage uH is also unavailable or no such provision exists. The voltage supply 27 for the control unit 10 and the test voltage supply 40 can be combined in one device. If an energy store 41 is provided, then this preferably also serves to supply energy to the control unit 10. The switch 42 can equally be integrated in the test voltage supply 40 or in such a device. The switch 42 can be implemented as electronic components, such as transistors. In other words, the test voltage supply 40 can also have outputs which can be switched on and off electronically for the test voltage uT.

When the disconnection device 20 is open and the switch 42 is simultaneously closed, theft monitoring and checking of the bypass diodes 8 (FIG. 4) for a failure are possible by acquiring the test voltage uT by the test voltage measuring unit 30 and/or by acquiring the test current iT or the respective string test current iT1-iTn by the current measuring units 14. If the string switching devices 15′ are individually controlled, a string-related output of the theft message DM or a failure message AM is possible. In the present example, this occurs by a radio data transmitter 43 which has a data link with the control unit 10. The data transmitter 43 is, for example, a GSM module with a corresponding antenna 44. Z designates a superordinate central facility for operation and monitoring of the PV system 100, which is connected to a corresponding receiver component.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for recognizing theft of at least one photovoltaic (PV) module of a PV system, which has at least one PV string, connected in parallel, of serially connected PV modules for supplying a field voltage, wherein each of the PV modules has a plurality of serially connected PV cells, the method comprising:
providing bypass diodes connected in an anti-parallel manner for protecting said plural serially connected PV cells;
connecting, during a non-feeding operation, a test voltage that is negative relative to the field voltage to said at least one PV string to set a test current through the bypass diodes; and
automatically outputting a theft message when one of the test current changes at a given test voltage and the test voltage changes at a given test current.

19. The method as claimed in claim 18, wherein the theft message is output when, at a given test current, a presently acquired test voltage is reduced by approximately a sum of forward voltage values of all the bypass diodes of a PV module or an integral multiple of the forward voltage values of all the bypass diodes of the PV module.

20. A method for recognizing a failure of at least one bypass diode of a photovoltaic (PV) module in a PV system, which has at least one PV string, connected in parallel, of serially connected PV modules for supplying a field voltage, wherein each of the PV modules has a plurality of serially connected PV cells and a plurality of bypass diodes, serially connected thereto in an anti-parallel manner, for protecting the serially connected PV cells, the method comprising:
connecting, during a non-charging operation, a test voltage that is negative relative to the field voltage to said at least one PV string of serially connected PV modules to set a test current through the bypass diodes; and
automatically outputting a failure message when a presently acquired test voltage reduces in comparison with a previously measured comparison voltage by approximately an integral multiple of a forward voltage of one of the bypass diodes.

21. A method for recognizing a failure of at least one bypass diode of a photovoltaic (PV) module in a PV system, which has at least one string, connected in parallel, of serially connected PV modules for supplying a field voltage, wherein each of the PV modules have a plurality of serially connected PV cells and a plurality of bypass diodes, serially connected thereto in an anti-parallel manner for protecting the PV cells, the method comprising:
connecting, during a non-charging operation, a test voltage that is negative relative to the field voltage to said at least one PV string of serially connected PV modules to set a test current through the bypass diodes; and
automatically outputting a failure message when, because of an open-circuit state of at least one of the bypass diodes instead of the test current to be set, only a residual current smaller in comparison therewith can be set.

22. The method as claimed in claim 18, wherein said at least one PV string comprises plural strings, each of said plural strings is connected in parallel, wherein a respective string test current is set in a respective one of said plural strings to recognize one of a string-related theft and bypass diode failure.

23. The method as claimed in claim 22, wherein the respective string test current is set cyclically in individual ones of said plural strings.

24. A photovoltaic (PV) sub-generator junction box for a PV system, comprising:
a plurality of electrical terminals for respectively connecting to a plurality of PV string lines, each of the plural PV string lines having a plurality of serially connected PV modules, each with a plurality of serially connected PV cells; and
a sub-generator terminal for connecting to a PV sub-generator line of a remotely located central PV inverter;
an electronic control unit, the PV sub-generator junction box being configured for switching a test voltage that is negative relative to a field voltage generated by said PV modules to the PV sub-generator line during a non-feeding operation such that a test current through at least one bypass diode of the PV modules can be set;
at least one of a voltage measuring unit for acquiring the test voltage and a current measuring unit for acquiring the test current;
wherein at least one of a theft message is output by the control unit when at least one of the test current and the test voltage changes; and
wherein a failure message for the at least one bypass diode is output by the control unit when a presently acquired test voltage is reduced in comparison with a previously measured comparison voltage by approximately an integral multiple of a forward voltage of one of the at least one bypass diode or when, because of an open-circuit state of one of the at least one bypass diode instead of the test current to be set, only a residual current smaller in comparison therewith can be set.

25. The PV sub-generator junction box as claimed in claim 24, wherein the theft message is output when, at a given test current, a presently acquired test voltage is reduced by approximately a sum of forward voltage values of all said at least one bypass diode of a PV module or an integral multiple of the forward voltage values of all said at least one bypass diode.

26. The PV sub-generator junction box as claimed in claim 24, further comprising, for each of said plural electrical terminals a string switching device which is controllable by the control unit for switching on a respective one of the PV string lines, and wherein only a respective string switching means for setting a respective one of the PV string lines test current in the respective one of the PV string lines is cyclically controllable for outputting one of a string-related theft message and failure message.

27. The PV sub-generator junction box as claimed in claim 25, further comprising, for each of said plural electrical terminals, a string switching device which is controllable by the control unit for switching on a respective one of the PV string lines, and wherein only a respective string switching means for setting a respective string test current in the respective one of the PV string lines is cyclically controllable for outputting one of a string-related theft message and failure message.

28. The PV sub-generator junction box as claimed in claim 24, wherein the PV string lines are connected to a bus bar of the PV sub-generator junction box, the PV sub-generator junction box further comprising:
a disconnection device which is controllable by the control unit for disconnecting the PV sub-generator line from the bus bar;
a test voltage supply for providing the test voltage; and
a switch which is controllable by the control unit for switching the test voltage to the bus bar.

29. The PV sub-generator junction box as claimed in claim 27, wherein the test voltage supply for electrical supply is connected on an input side to the sub-generator terminal of the PV sub-generator junction box.

30. The PV sub-generator junction box as claimed in claim 29, wherein the test voltage supply includes an energy store which is chargeable by the sub-generator terminal.

31. A photovoltaic (PV) inverter for a PV system, comprising:
at least one sub-generator terminal for connection of at least one of:
a respective PV sub-generator line of a plurality of PV sub-generator junction boxes or a respective PV main direct current line of a PV generator junction box connected in between the PV inverter and the plurality of PV sub-generator junction boxes;
a power connector for connection to a power supply network;
a central control unit for controlling the PV inverter;
an auxiliary voltage supply for providing an auxiliary voltage; and
a coupling switch for feeding the auxiliary voltage into the at least one of the PV sub-generator line and PV main direct current lines.

32. The PV inverter as claimed in claim 31, wherein the auxiliary voltage supply provides an auxiliary voltage that is negative relative to a fed-in field voltage received by the power converter, a positive auxiliary voltage and an alternating auxiliary voltage.

33. A photovoltaic (PV) system having at least one central PV inverter and a plurality of PV sub-generator junction boxes as claimed in claim 24.

34. The photovoltaic (PV) system of claim 33, wherein the at least one central PV inverter comprises:
at least one sub-generator terminal for connection of at least one of:
a respective PV sub-generator line of a plurality of PV sub-generator junction boxes or a respective PV main direct current line of a PV generator junction box connected in between the PV inverter and the plurality of PV sub-generator junction boxes;
a power connector for connection to a power supply network;
a central control unit for controlling the PV inverter;
an auxiliary voltage supply for providing an auxiliary voltage; and
a coupling switch for feeding the auxiliary voltage into the at least one of the PV sub-generator line and PV main direct current lines.

35. The PV system as claimed in claim 33, wherein the PV system includes at least one PV generator junction box connected between the at least one central PV inverter and the plurality of PV sub-generator junction boxes.

36. The method of claim 18, wherein the non-feeding operation occurs during at least one of evening and night hours.

37. The PV sub-generator junction box as claimed in claim 29, wherein the energy store is an accumulator.
